(19) United States
(12) Patent Application Publication
(10) Pub. No.: US 2011/0302203 A1
(43) Pub. Date: Dec. 8, 2011

(54) SYSTEM AND METHOD FOR PROVIDING SEARCHES INCLUDING A "WITH" SEARCH PARAMETER

(75) Inventors: James Tracy, Batavia, IL (US); Derek McKenzie, Franklin Park, IL (US); James Cordes, Franklin Park, IL (US); Jorge Cordova, Villa Park, IL (US); Jordan Strauch, Westment, IL (US)

(73) Assignee: EZLOCAL.COM, INC.

(21) Appl. No.: 13/155,082

(22) Filed: Jun. 7, 2011

Related U.S. Application Data
(60) Provisional application No. 61/352,115, filed on Jun. 7, 2010.

(51) Int. Cl. G06F 17/30

(52) U.S. Cl. 707/769; 707/E17.014

(57) ABSTRACT

A system and method for performing searches may include storing data available for searching. In response to receiving a search request includes a “what” search parameter and a “with” search parameter from a user, the data using the “what” and “with” search parameters may be searched, and search results may be generated. The search results may be returned to a user who submitted the search request.

### RELATED APPLICATIONS

This patent application claims priority to co-pending U.S. Provisional Patent Application Ser. No. 61/352,115 filed Jun. 7, 2010, the entire contents of which are herein incorporated by reference in their entirety.

### BACKGROUND

Since the early days of the Internet, searching has been important for consumers searching for goods and services and for commercial entities for reaching consumers. Over the years, searching algorithms have evolved as content, formats, and vast amounts of data have evolved. As an example, in the early days of the Internet, location-based searching did not exist, which resulted in irrelevant search results being reported to a searcher. By way of example, a search for “pizza restaurants” by someone in Dallas, Tex. would receive search results including pizza restaurants from around the country or world—most being irrelevant to the searcher since any pizza restaurant outside of a 2-mile radius from the searcher is generally considered too far for a searcher to travel to purchase a pizza. Once location-based searching was introduced, local reach of commercial entities exploded as searchers were able to geographically target their searches. As understood in the art, location-based searching is defined by a “where” search parameter.

While searching has evolved over the years, shortcomings still exist in existing search systems, including most of the major search systems. As an example, search results still tend to be vast and unorganized. Keywords are generally used by commercial entities to better enable searchers to locate a website. The keywords are generally matched with a “what” search parameter to determine whether the search results should include the content that includes the keywords. Such a search scheme provides unpredictable results because commercial entities do not always use the same terminology. There is an entire industry for search engine optimization to provide commercial entities better ways to be “found” or listed during an online search. Search engine optimization is generally a result of commercial entities desiring to have more predictability and visibility from online user searches.

### SUMMARY

To further improve the ability for searchers to have more precise and predictable search results, the principles of the present invention provide for the use of a “with” search parameter in addition to the traditional “what” and “where” search parameters. The “with” search parameter enables a user to submit one or more additional criteria to a search algorithm that prioritizes the “with” search parameter while performing the search. In one embodiment, the “with” search parameters may be predefined and selectable, and provide a searcher with the ability to select which, if any, “with” search parameter(s) to be part of the search. The selectable “with” search parameter(s) may include selectable indicia. Selectable indicia may include graphical icons, “badges,” words, or otherwise, that may be selectable by a searcher “clicking” or pressing on the indicia, depending on the user interface, or an associated graphical user selection element, such as a check-box. The selectable indicia may be a graphical representation of a category of an underlying category being represented (e.g., wheelchair image representing handicap accessible). Alternatively, a “with” search parameter may be entered in a text entry field using natural language, keyword searching, identifiers to identify the “with” search parameter (e.g., “with: handicap”), or otherwise, so that a search algorithm can identify search results with the “with” search parameter along with either or both “what” and “where” search parameters.

Content providers (e.g., commercial establishments) may selectively add “with” search parameters for categorizing their content (e.g., website). For example, a local restaurant may add a “healthy choice” search parameter identifier to its content. In one embodiment, in order for a commercial establishment to selectively add the search parameter identifier by declaring or claiming that the commercial establishment meets certain criteria that qualifies the commercial establishment be recognized for providing the search parameter. In the example of the local restaurant being a “healthy choice” restaurant, the local restaurant must agree to meet at least a certain number of pre-established criteria out of a total possible number of pre-established criteria (e.g., at least three out of six from a list including: (i) no use of hydrogenated fats, (ii) offering at least three low calorie (e.g., 400 calories maximum) meals, (iii) displaying Weight Watchers points system, (iv) displaying calories per food item, (v) no use of MSG, and (vi) use of organic ingredients).

One embodiment of a system for performing searches may include an input/output (I/O) unit configured to receive and transmit over a communications network. A memory may be configured to store data. A processing unit may be in communication with the I/O unit and memory, where the processing unit may be configured to receive search request data via the I/O unit. The search request data may include a “what” search parameter and a “with” search parameter. The processing unit may further be configured to, in response to receiving the “what” and “with” search parameters, (i) perform a search of data stored in the memory using the “what” and “with” search parameters and (ii) return results of the search via the I/O unit to a requestor of the search request.

One embodiment of a method for performing searches may include storing data available for searching. In response to receiving a search request includes a “what” search parameter and a “with” search parameter from a user, the data using the “what” and “with” search parameters may be searched, and search results may be generated. The search results may be returned to a user who submitted the search request.

One embodiment of a method for providing an online search system may include enabling a commercial entity to submit qualification information indicative of services provided in association with a “with” search parameter. A determination may be made as to whether the qualification information submitted by the commercial entity qualifies the commercial entity to have a badge assigned to the commercial entity. A badge may be assigned to the commercial entity, where the assignment may include associating a badge with content associated with the commercial entity. In response to receiving a search request that includes a “with” search parameter, a search may be performed for the badge in addition to the content associated with the commercial entity. Search results that include the content associated with the commercial entity and the badge may be generated in response to determining that the content and badge at least in part match the search request.

### BRIEF DESCRIPTION OF THE DRAWINGS

Illustrative embodiments of the present invention are described in detail below with reference to the attached drawing figures, which are incorporated by reference herein and wherein:

FIG. 1A is a screen shot of an illustrative graphical user interface (GUI) 100a, in this case a website, configured for enabling a user to interface with a search engine system for performing online searches in accordance with the principles of the present invention;

FIG. 1B is a screen shot of an illustrative GUI on a mobile device, such as a mobile telephone;

FIG. 2 is a screen shot of an illustrative search results screen showing search results in response to performing a search in which “where” and “with” search parameters were used;

FIG. 3 is a screen shot of an illustrative GUI displaying a commercial entity profile or listing that is displayed in response to a searcher selecting a listing from a search result listing (FIG. 2);

FIGS. 4A-4N are screen shots of illustrative profile entry screens 400a-400n, respectively, that enable a commercial entity to submit information to receive or be awarded an indicia or badge to indicate that the commercial entity meets sufficient criteria to qualify for providing a service, and therefore, enable association and display of the badges with listing content of the commercial entity;

FIG. 5 is a screen shot of an illustrative pop-up window that provides for a brief description of the meaning of the “with” search parameter topics or badges;

FIG. 6 is an illustration of a network environment that includes a search system server that is operating on a communications network, such as the Internet;

FIG. 7 is a block diagram of illustrative software modules that provide for commercial entities to obtain badges and searches using a “with” search parameter associated with the badges;

FIG. 8 is a flow diagram of an illustrative process for a search algorithm that includes a “with” search parameter to be executed on a computing system, such as shown in FIG. 6; and

FIG. 9 is a flow diagram of an illustrative process for performing searches.

### DETAILED DESCRIPTION OF THE DRAWINGS

Reference will now be made in detail to the embodiments of the present inventive concept, examples of which are illustrated in the accompanying drawings, wherein like reference numerals refer to the like elements throughout. The embodiments are described below in order to explain the present inventive concept by referring to the figures.

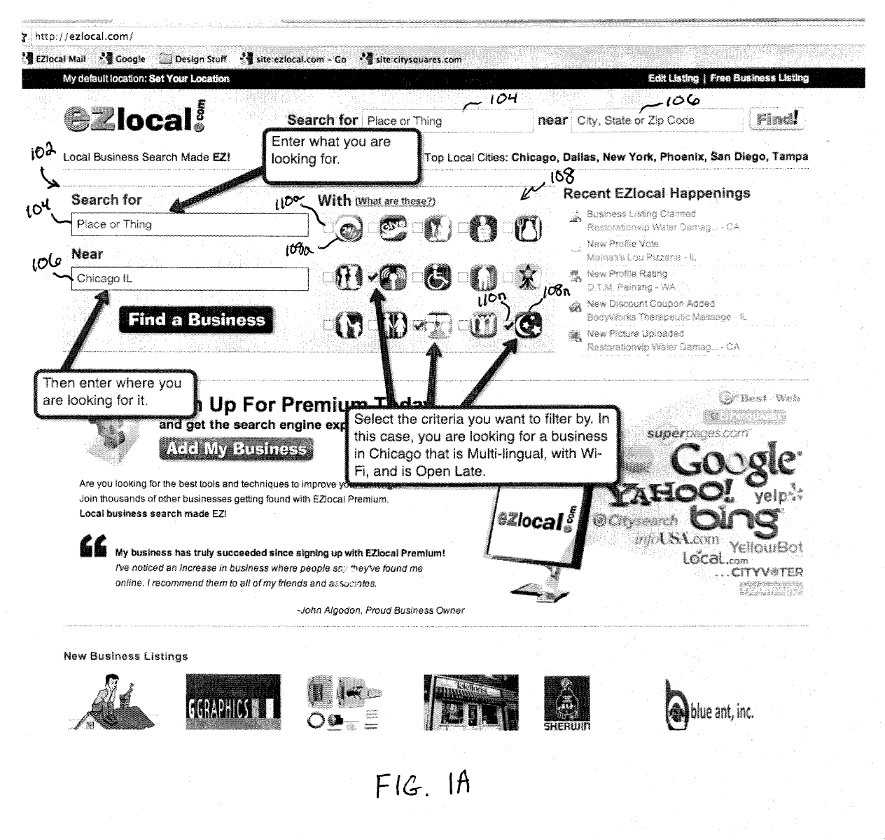

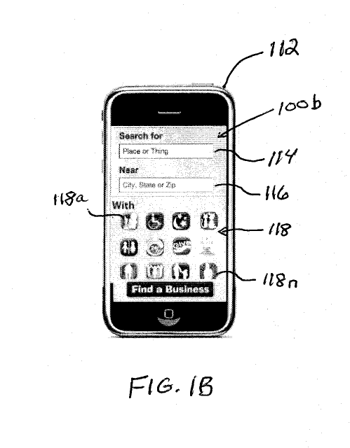

With regard to FIG. 1A, a screen shot of an illustrative graphical user interface (GUI) 100a, in this case a website, configured for enabling a user to interface with a search engine system for performing online searches in accordance with the principles of the present invention is shown. The graphical user interface 100a includes a user entry region 102 that enables a searcher to enter up to three search parameters, including a “what” search parameter in a “Search for” text entry field 104 and a “where” search parameter in a “Near” text entry field 106. In addition to the “what” and “where” search parameters, a searcher is provided with the ability to select one or more “with” search parameters by selecting one or more indicia 108a-108n (collectively 108), such as graphical icons or “badges.” As shown in the GUI 100a, GUI elements 110a-110n (collectively 110), represented as check-boxes, associated with respective indicia 108 may be selected by the searcher. It should be understood that the indicia 108 associated with the different “with” search parameters may be selected in any way in which a GUI may operate (e.g., touch screen if using a mobile device or pointing device “click” if using a computer). Adding this third “with” search parameter essentially adds a third dimension to traditional two-dimensional searching.

In operation, the searcher may enter one or more of the “what,” “where,” and “with” search parameters. For example, the searcher may enter a “what” search and “with” search parameter without a “where” search parameter. Alternatively, the search may enter a “where” search parameter and a “with” search parameter without entering a “what” search parameter. Still yet, a searcher may simply enter a “with” search parameter. Of course, the more search parameters entered, the more precise the search results become. A searcher may enter words or phrases into the “what” and “where” search parameter text entry fields 104 and 106, respectively. In one embodiment, the searcher may enter a “with” search parameter by selecting one or more of the indicia 108, as described above. It should be understood that rather than having multiple text entry fields 104 and 106 for the “what” and “where” search parameters, a single text entry field may be utilized and a processing system may automatically identify the “what” and “where” search parameters. In yet another embodiment, a single text entry field may enable entry of the “what,” “where,” and “with” search parameters by using natural language, keyword searching, inclusion of identifiers prior to the parameter(s), or otherwise.

A search algorithm utilized to search for results using the three search parameters may prioritize the search based on which search parameters are entered. If, for example, “what” and “with” search parameters are entered but no “where” search parameters are entered, then the search algorithm may prioritize the “what” search parameter over the “with” search parameter (i.e., search for matches of the “what” search parameter before further refining the search results by searching for the “with” search parameter within the results of searching for the “what” search parameter). If a “where” search parameter were entered in addition to the “what” and “with” search parameters, then the search algorithm may prioritize the “what” search parameter over the “with” search parameter, and the “with” search parameter over the “where” search parameter.

In one embodiment, multiple “with” search parameters may be selected by a searcher by selecting multiple indicia 108 or check-boxes 110. The searcher may not prioritize each “with” search parameter. Alternatively, the “with” search parameters may not be prioritized. The search algorithm used may be optimized to give the best search results to a searcher by using a points system. Points may be assigned to the words that are entered in the “what” and “where” text entry fields 104 and 106. For example, a searcher that currently searches for “Kodak camera” (“what” search parameter) in area code “60641” (“where” search parameter) and gets certain results. The searcher gets better and different results than a search for “camera” (“what” search parameter) in Chicago, Ill. (“where” search parameter). Priority points may be assigned to the “with” search parameters, as represented by the selectable indicia 108 or “badges,” as well, and the highest scores in the search results may be displayed first.

Priority values may be defined by or set by the searcher. For example, the searcher may pre-establish preferences that rank the “with” search parameters in order of priority (e.g., “handicap” 1, “child friendly” 2, “healthy meals” 3, etc.). Alternatively, the search may rank search priority by selection order of the indicia 108 representative of “with” search parameters. Alternatively, data entry fields or GUI elements (not shown) may be utilized to set rank search priority of the “with” search parameters.

The search system may be configured to be intuitive. That is, if somebody searches coffee shop (“what” search parameter) in Chicago (“where” search parameter) and selects or enters Wi-Fi, Open Late, and Public Restroom “with” search parameters, exact matches are displayed first. If there are no exact matches, Chicago receives the lowest points and the nearest coffee shop outside Chicago with the other criteria are displayed first. Coffee shops may be assigned the highest priority points because if the searcher just wanted a public restroom that is open late, the searcher would not have entered Coffee shop (i.e., no “what” search parameter would have been entered). The results that follow may be coffee shops in Chicago with two of the three other “with” search parameter criteria met so the user can make a choice. The searcher can also narrow or expand the search results at every step of their search. In one embodiment, the search can require that all “with” search parameters be met or that a certain number of the total desired “with” search parameters be met.

If the search system is configured to be intuitive, the search system may also be configured to be logical to support the intuitive aspects of the search system. If priorities are pre-set by a searcher, the priorities may be overridden by the search system where the priorities set by the search are illogical for a given search. As an example, if the searcher at 10 pm searches for a (i) public restroom in a business that is (u) open late (“with” search parameters) in Chicago (“where” search parameter), the open late “with” search parameter is prioritized over the public restroom “with” search parameter because it does not help the searcher to know where a public restroom is if the business with the public restroom is not currently open. It should be understood that many other intuitive examples could be provided, but that the concept of prioritizing the “with” search parameter(s) or electing to display results based on certain specified (e.g., “with” search parameter) or unspecified (e.g., day of week, time of day) search criteria are considered to be within the principles of the present invention.

All or a subset of the “with” search parameter indicia 108 or badges (e.g., 15 soft-buttons or selectable icons) may appear on every page. Again, the search process may utilize a point system with a score assigned to the best possible results. In one embodiment for ranking search results, points are assigned if a portion of a name “matches” one or more words associated with a “with” search parameter or badge. As an example, Bob's 24 Hour Locksmith will rank just above Joe's Locksmith Services when a searcher selects a 24-hour indicia for a “with” search parameter even if both businesses have associated themselves with the 24-hour “with” search parameter because the term “24 hour” is part of the name. As understood in the art, if a score were not given to every word in every search, results would be random each time.

With regard to FIG. 1B, a screen shot of an illustrative GUI 100b on a mobile device 112, such as a mobile telephone, is shown. The mobile device environment may be the same, analogous, or different from that of a computer since the computer generally has more surface area on a screen. However, as shown, the searcher has the ability to enter search request information into “what” and “where” search parameter text entry fields 114 and 116, respectively, and select one or more “with” search parameter indicia or badges 118a-118n (collectively 118) to specify desired “with” search parameter(s) to use during a search. The badges 118 displayed on the GUI 100b may be soft-buttons that a user may touch to select or deselect for inclusion in a search. If the mobile device 112 is not touch screen enabled, then a non-touch screen GUI interface with non-touch screen selectable elements may be utilized, as understood in the art. While the GUI 100b of the mobile device search site may be slightly different, the functionality of the search system may perform in the same or similar manner to that of the web-based version (FIG. 1A).

The intuitive nature of the search system may utilize inherent features of the mobile device and/or other applications that reside on the mobile device 112. For example, because most mobile devices these days include geographic coordinates positioning (e.g., GPS) capabilities, the search system operating on the mobile device may use a current geographic coordinate positioning information determined or stored by the mobile device 112 as a default “where” search parameter. In one embodiment, the search system may display the current geographic location (e.g., Chicago) in the “where” search parameter text entry field 116. When performing a search, the searcher using the mobile device 112 may enter only “with” search parameter(s) and the “where” search parameter provided by the mobile device 112 would be utilized by the search system in performing the search. Of course, a user may override the current “where” search parameter and enter another “where” search parameter (e.g., another city or geographical location). The search system executing on the mobile device may communicate the raw geographic coordinates and the search system (e.g., server) remotely located on a network (e.g., the Internet) may convert the raw geographic coordinates to determine a geopolitical coordinate (e.g., zip code, city name, etc) for performing the search. In displaying the search results, if the mobile device has a mapping application residing thereon, such as Google Maps, the search system may communicate with that mapping application and display locations of the search results automatically or in response to a request by the searcher for viewing the search results on a map.

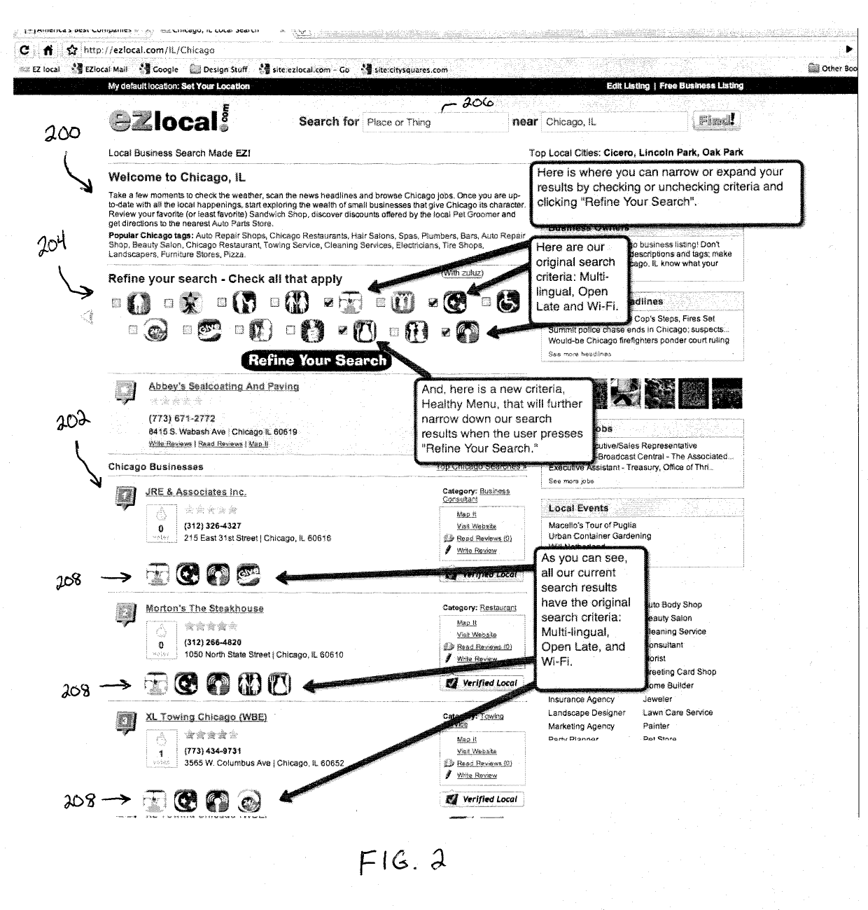

With regard to FIG. 2, a screen shot of an illustrative search results screen 200 showing search results in response to performing a search in which “where” and “with” search parameters were used is provided. As shown, the search results 202 include all local business within the Chicago, Ill. geographic area that identified themselves to be “multi-lingual,” “open late,” and “Wi-Fi” compliant. The user may further refine the search by selecting additional “with” search parameter indicia 204 or by adding a “what” search parameter in the “what” search parameter text entry field 206. In one embodiment, all or a subset of the “with” search parameter selectable indicia 204 may be available for selection on each search screen of the GUI 200. Alternatively, rather than displaying each of the search parameter selectable options, a “display ‘with’ search parameter” icon (not shown) or other technique (e.g., menu selection preferences) may be used to allow the, indicia 204 to be hidden on the search results page so as to save space on the GUI 200 and then displayed in response to the searcher selecting the “display ‘with’ search parameter” icon. As understood in the art, the searcher may select a result to display additional information of the particular search result. Although the search results 202 are shown to include “with” search results badges 208 that at least in part match the selected “with” search parameter indicia 204, it should be understood that the search results 202 may include listings that have not associated themselves with “with” search parameters. Of course, from a results effectiveness perspective, the listings that are associated with “with” search parameters may be displayed before listings without being associated with “with” search parameters due to ranking of the results with respect to the search parameters, as previously described.

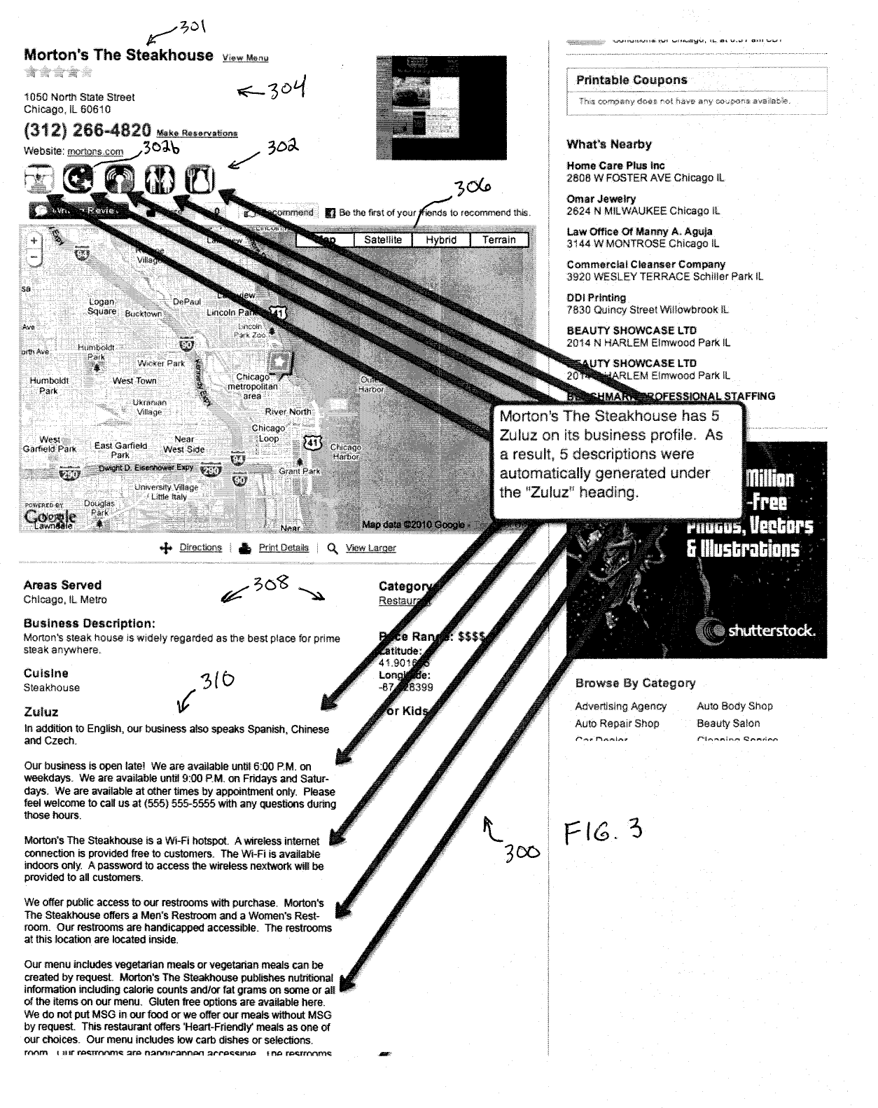

With regard to FIG. 3, a screen shot of an illustrative GUI 300 displaying a commercial entity profile or listing 301 that is displayed in response to a searcher selecting a listing from a search result listing (FIG. 2) is shown. As shown, indicia or badges 302 associated with the business provide are shown in addition to conventional search result information 304 (e.g., name, address, telephone number, etc.). In addition, a map 306 may be shown for a searcher to see where the selected search result (e.g., local business) is located. Below the map 306 is a listing of information 308 descriptive of the search result (e.g., “Areas Served,” “Business Description,” “Cuisine,” “Price Range,” GPS coordinates, etc.). In addition, descriptions 310 of the respective indicia 302, or commercially to be known as “ZuluZ,” are provided below the information 308 of the search result. For example, a description of the indicia 302b showing the moon and stars reads, “Our business is open late! We are available until 6:00 P.M. on weekdays . . . ” In one embodiment, the business itself may provide a customized description associate with the indicia 302 so as to be more personalized. Alternatively, “form” descriptions may be selectable by the commercial entity for display in association with the search results listing 301.

The information 308 on the profile 301 may be added and edited by the commercial entity. For the badges 302 that are associated with the commercial entity, as the commercial entity changes, the information that is used to determine whether the commercial entity is provided with each type of badge may be updated so that the commercial entity may be “awarded” with a certain category of badge or a certain category of badge withdrawn from the commercial entity. For example, if the commercial entity decides to become “green,” the commercial entity may answer the questionnaire associated with the “Green” badge. If the commercial entity meets the criteria for the search system to acknowledge that the commercial entity is “Green,” then a “Green” badge is associated with the commercial entity. Thereafter, searches for “green” content providers and other search parameters (e.g., “what” and “where” search parameters) that are determined to match the commercial entity's, may include the commercial entity's profile. As a result of the “green” “with” search parameter being added, an increase in ranking of the listing of the commercial entity may occur, thereby posting the listing of the commercial entity higher than had the “green” “with” search parameter had not been added.

The topics associated with indicia or badges may be extensive. TABLE I provides an example list of different topics that may be available for content providers (e.g., local businesses) to select for association with their content.

TABLE I
Topics for Badges

Green Committed Business
Senior Friendly Business
Pet Friendly Business
Charity Friendly Business
Community Friendly Business
Public Restrooms Available
Handicap Accessible
24-Hour Availability
Open Late
5, 10, 25 Positive Reviews
5, 10, 25 Thumbs Up Awards
America's Best Companies
Healthy Restaurant Menu

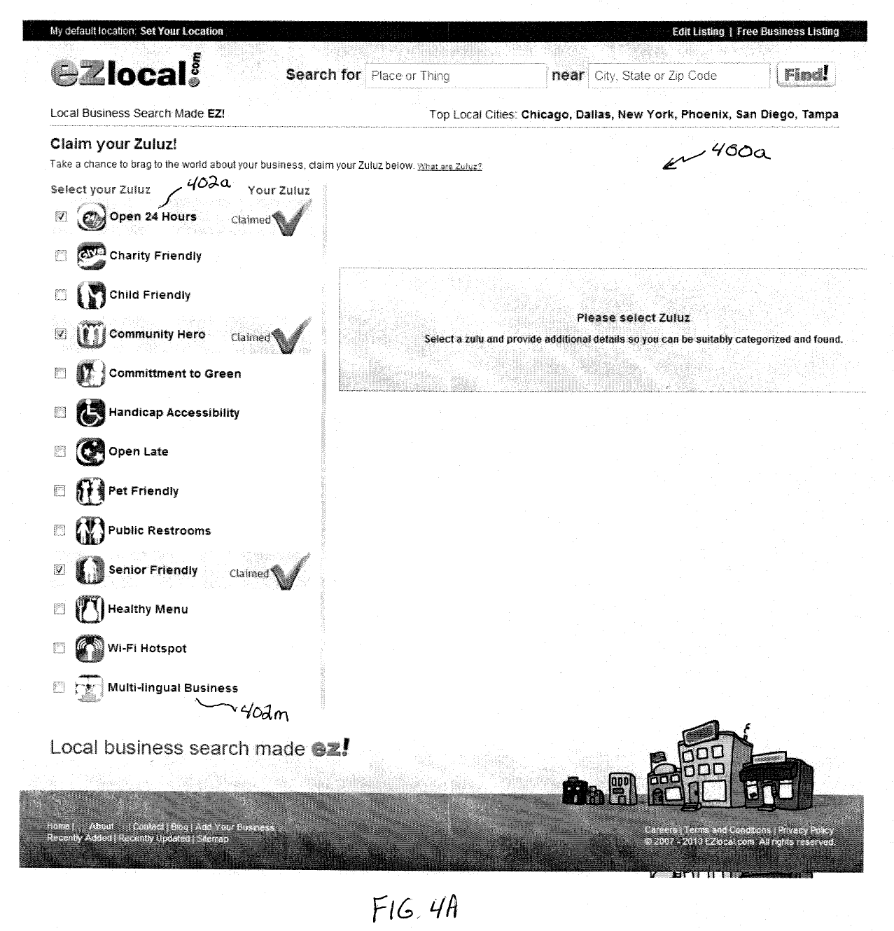

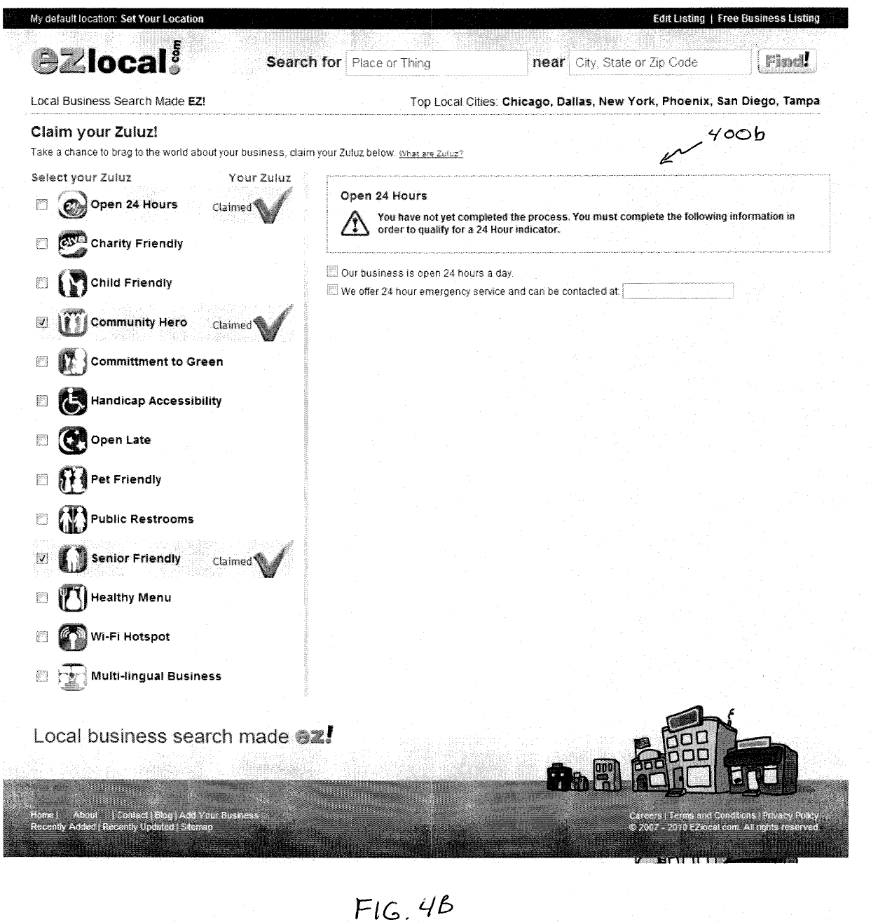

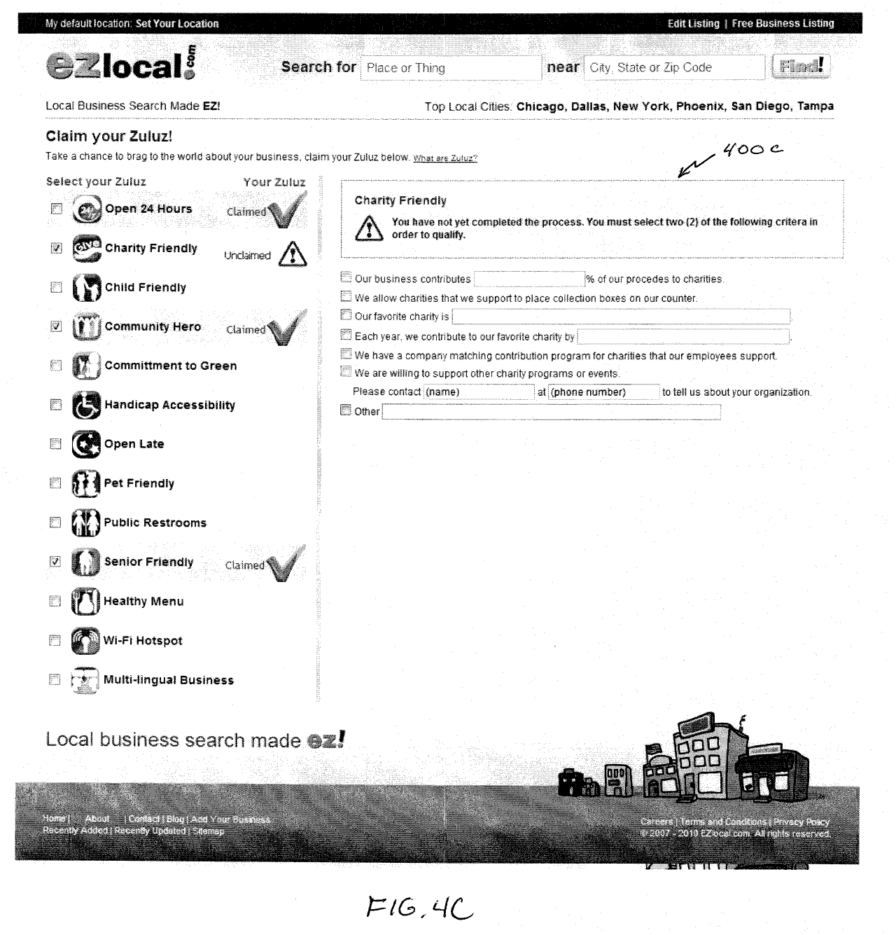

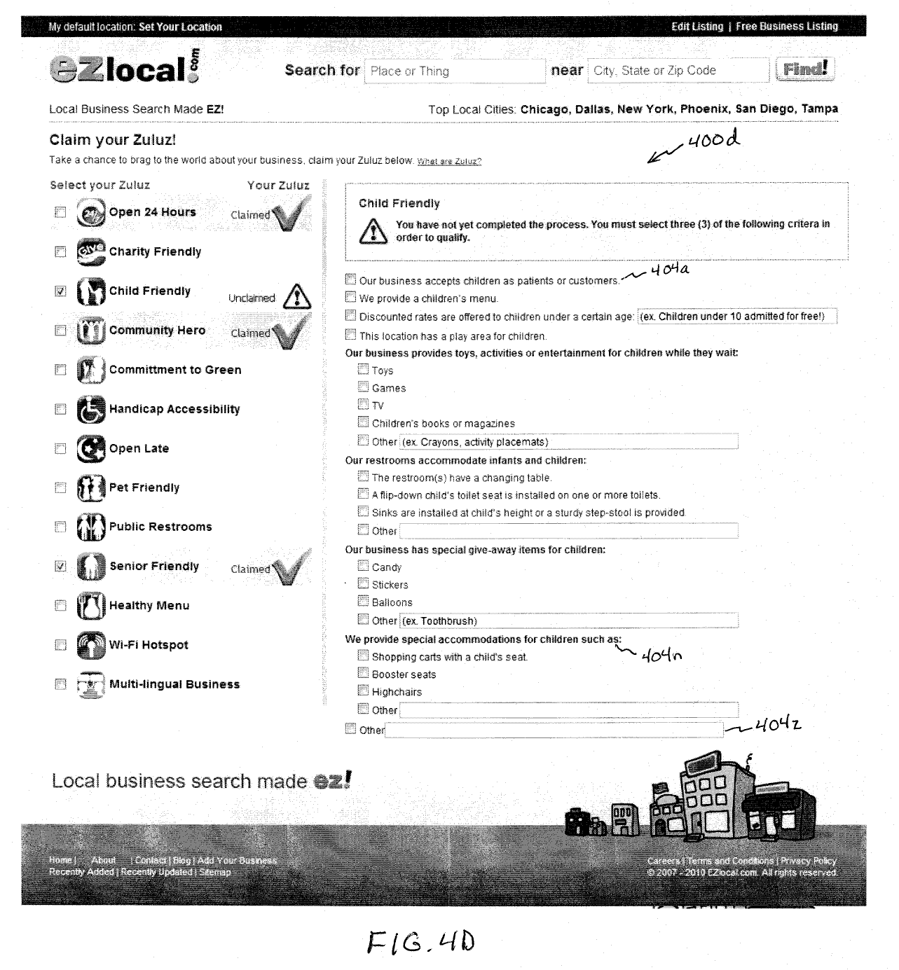

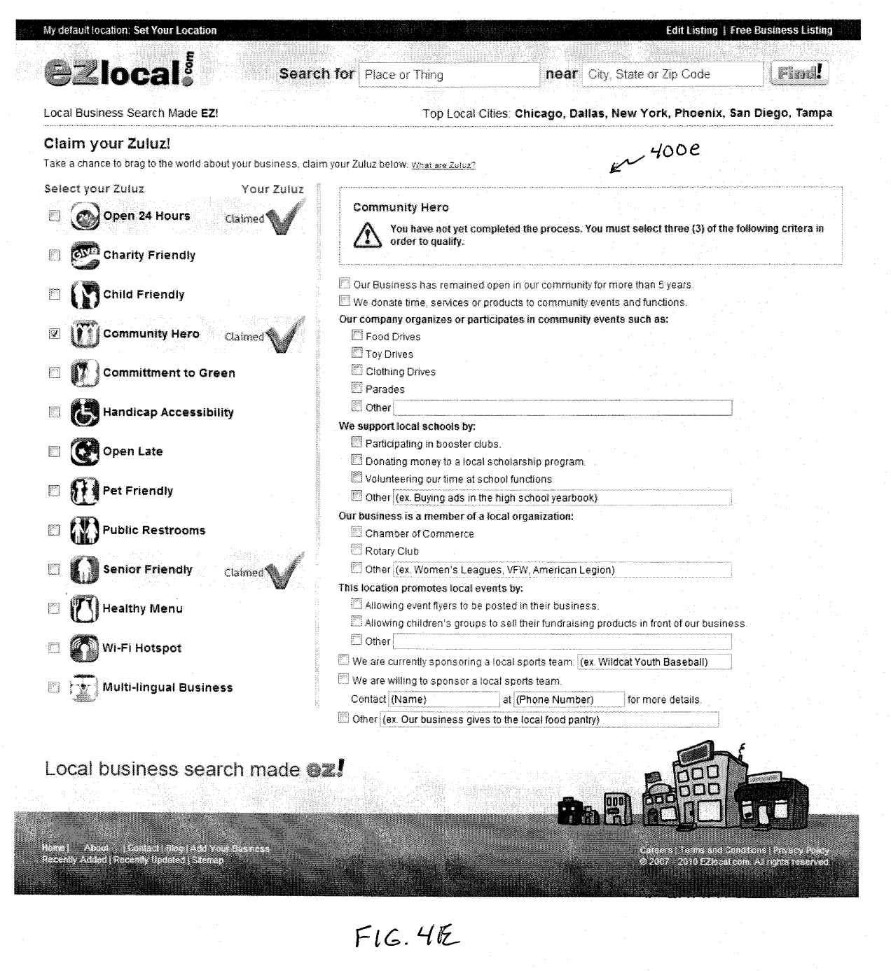

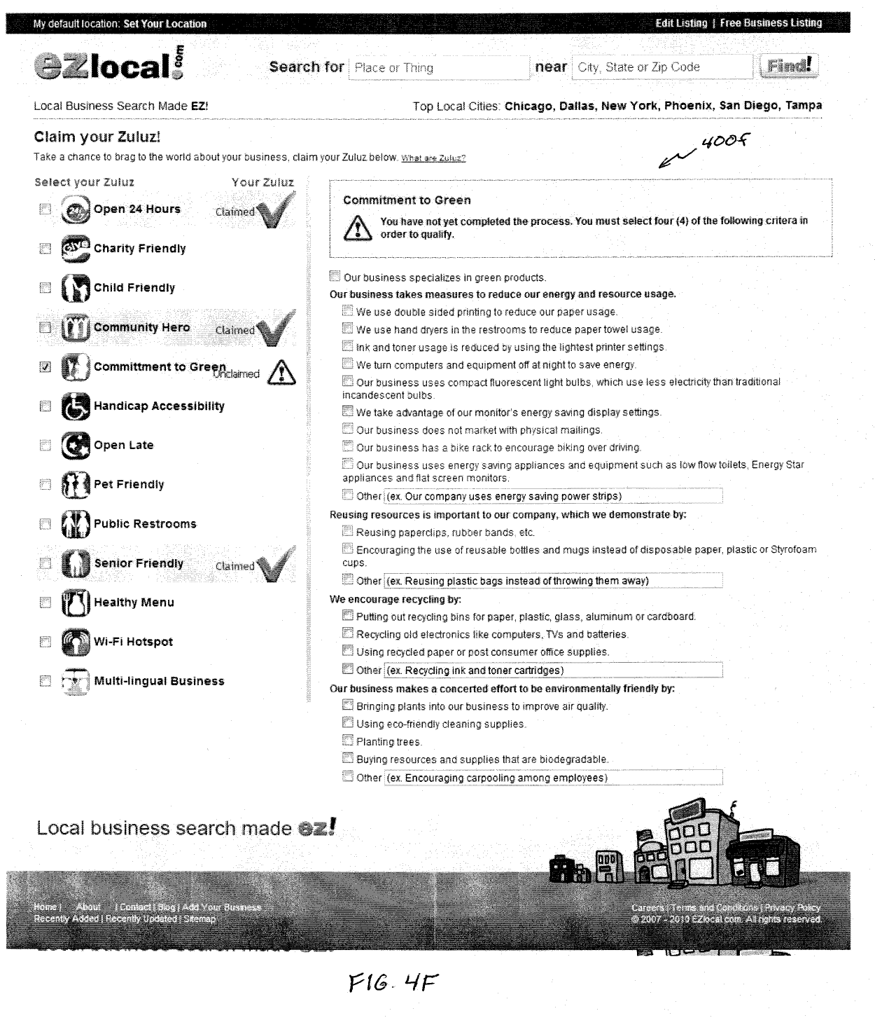

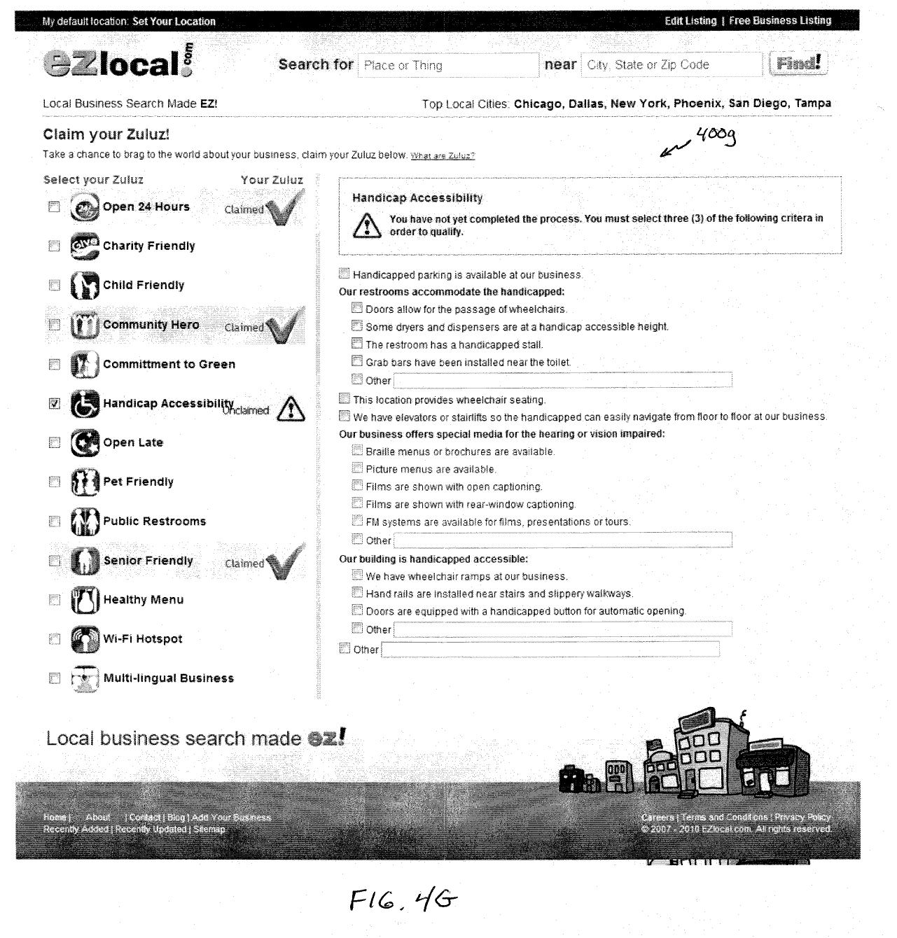

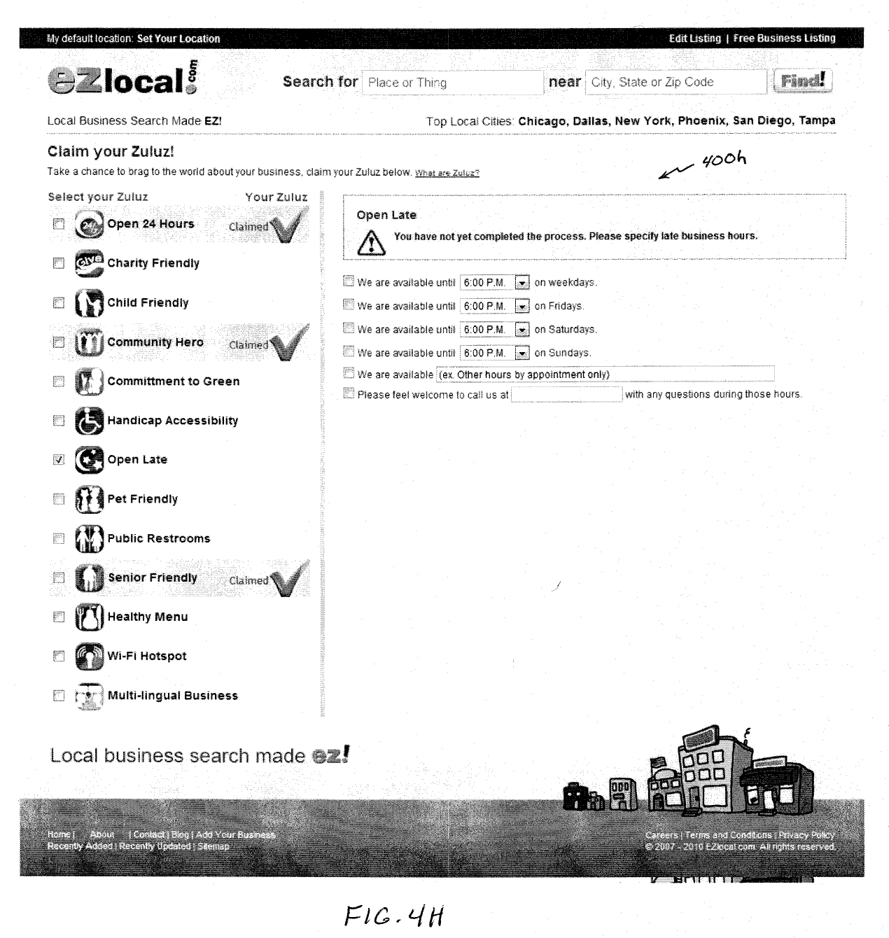

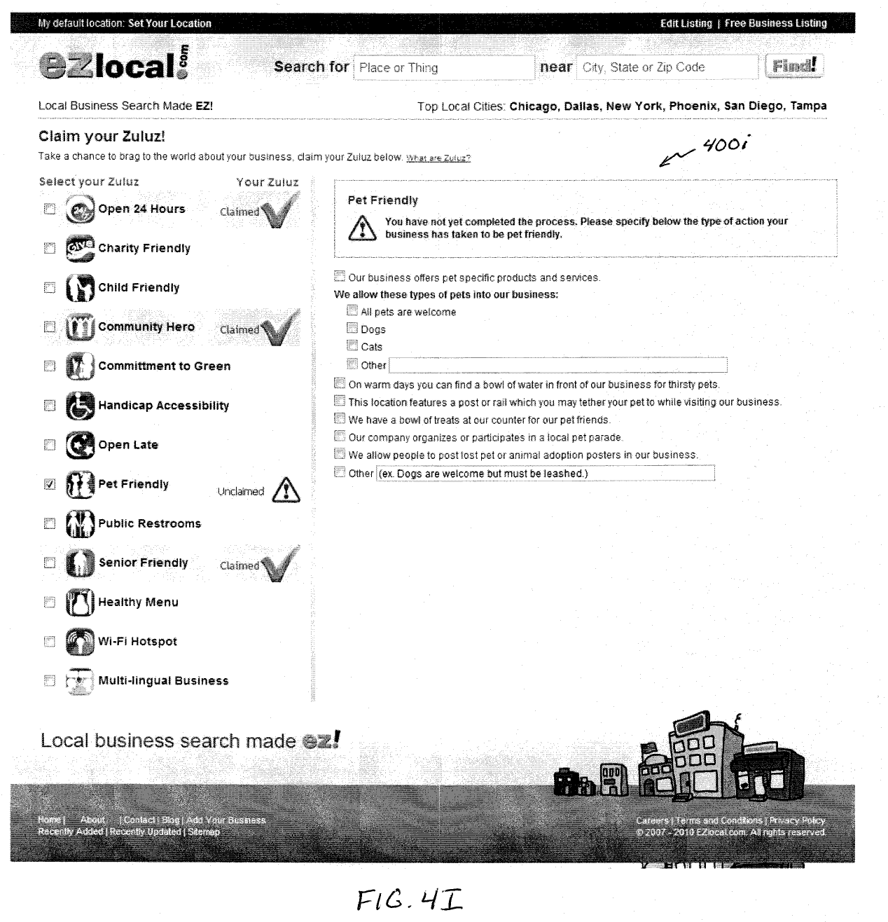

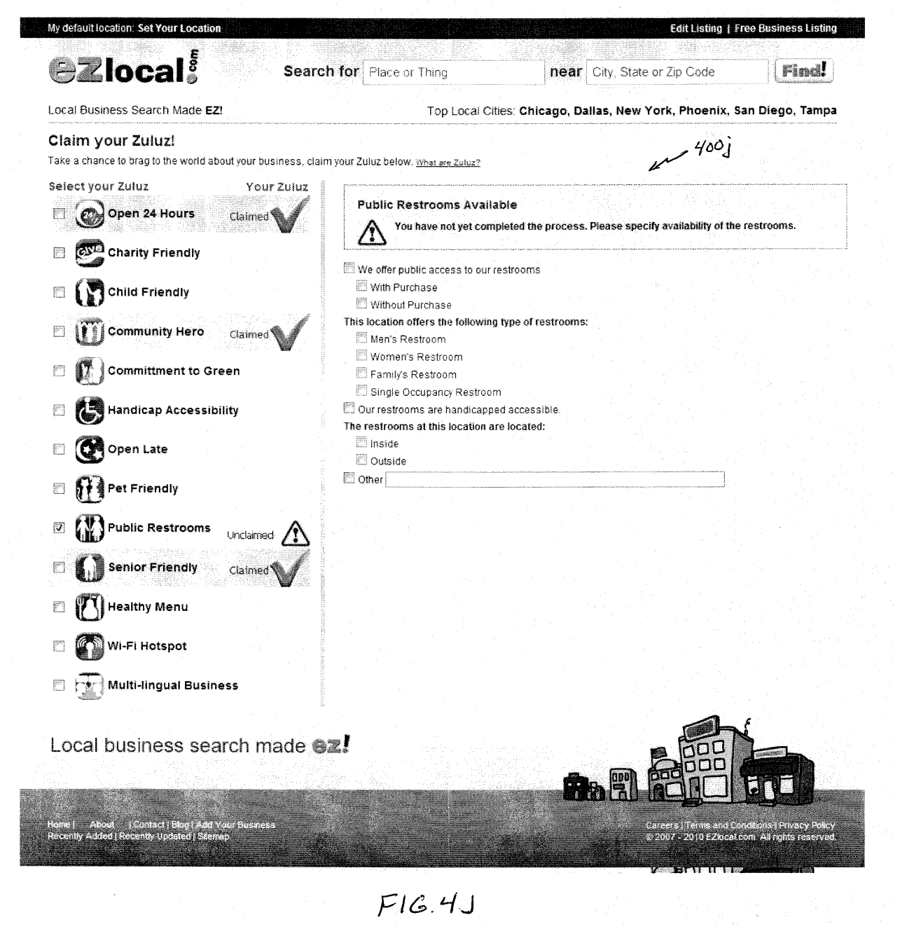

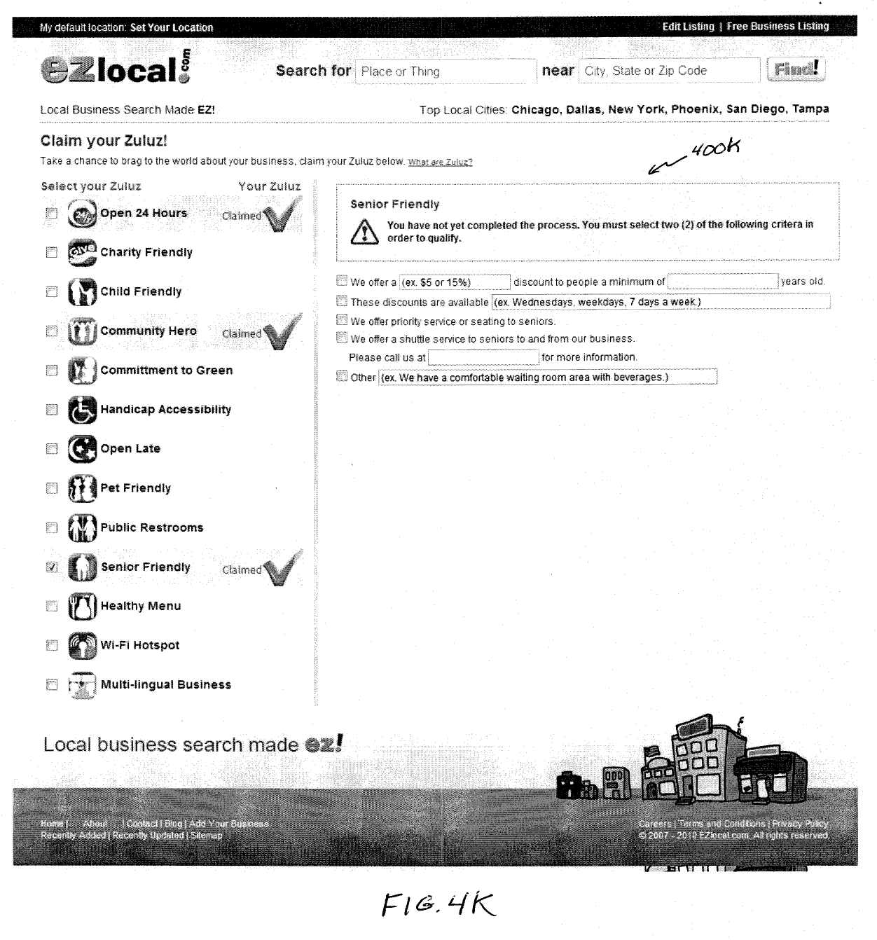

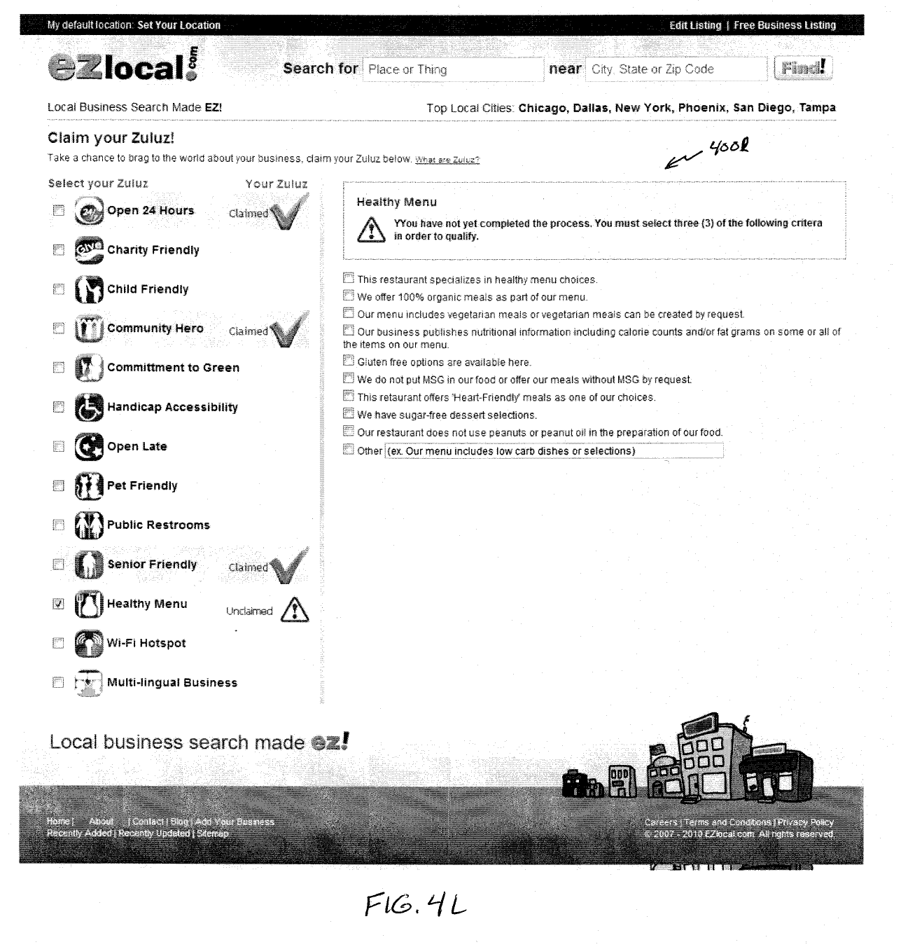

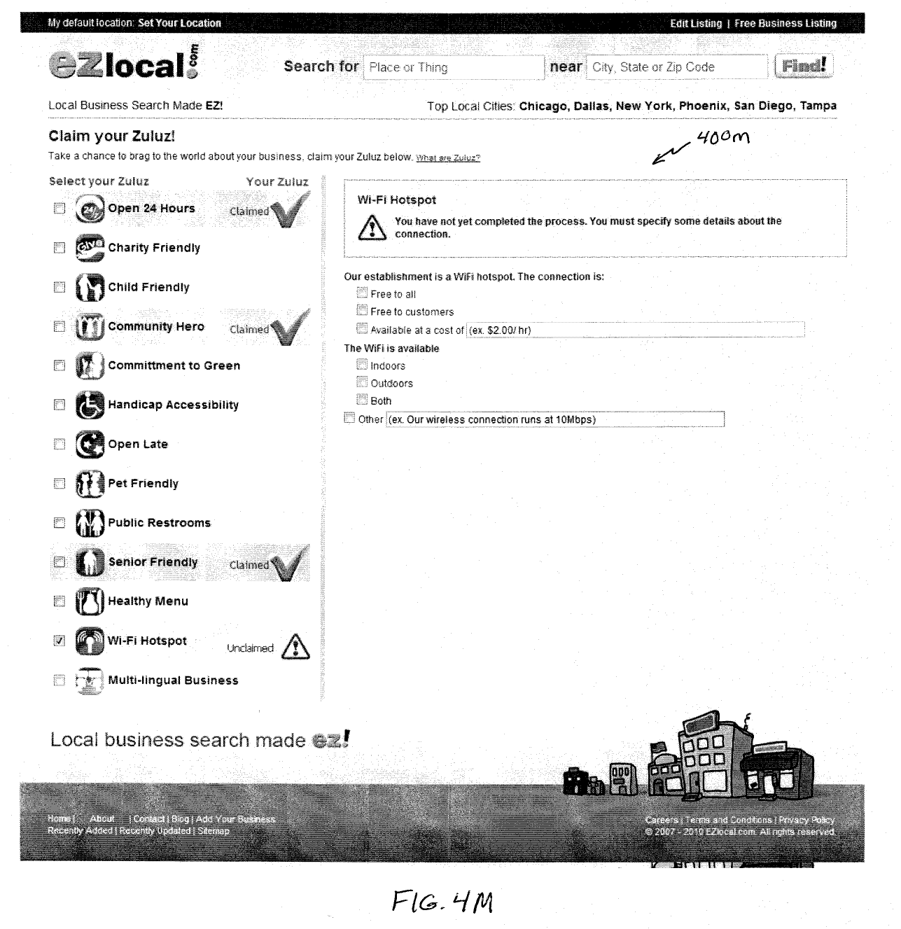

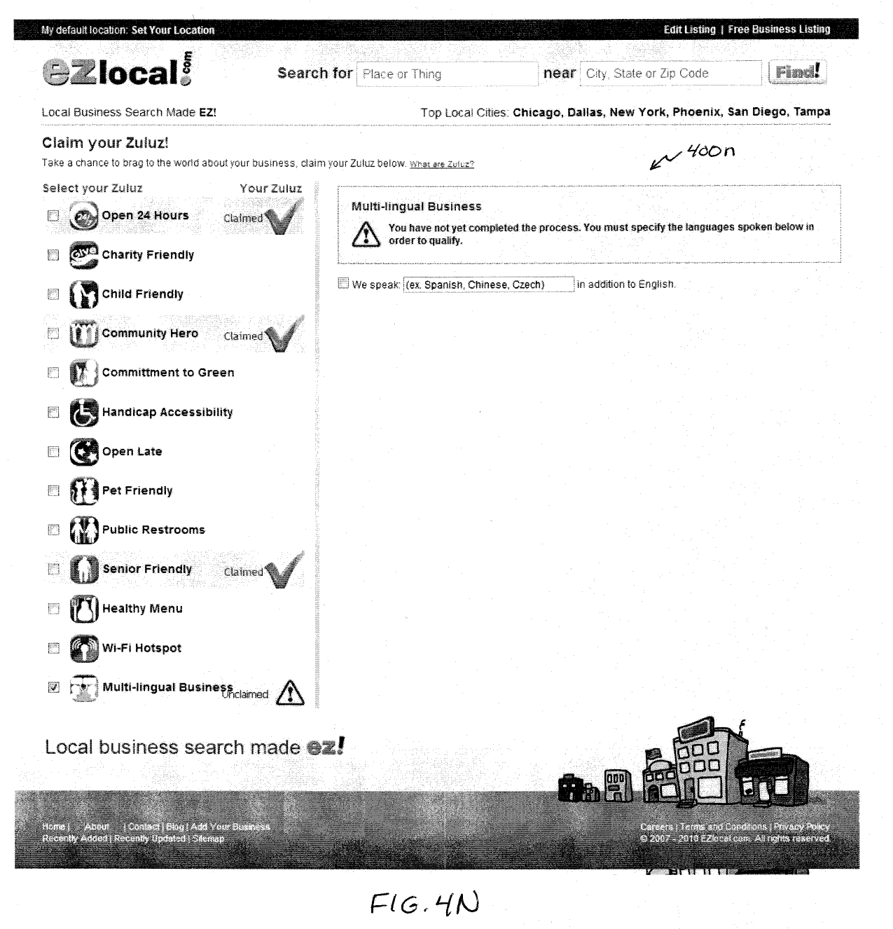

Each of the topics for the badges may include sub-categories to provide for a more refined search. The sub-categories may be available for the content providers to acknowledge when establishing or claiming the badges or indicia to be associated with the content when establishing a profile or listing for the search site TABLE II shows an illustrative list of sub-topics for select primary topics shown in TABLE I. It should be understood that additional and/or alternative sub-topics may be utilized in accordance with the principles of the present invention (See, FIGS. 4B-4N).

TABLE II

| | | | Charity | Community | Healthy |
|---|---|---|---|---|---|
| Green Business | Child Friendly | Senior Friendly | Friendly | Hero | Restaurant |
| Green Energy | Child's Menu | Senior Discounts | Breast Cancer | Chamber | Low Calorie |
| Badge | | | Badge | Member | Meals Offered |
| Green Energy | Child Discounts | Senior Assistance | Heart Association | Parade | Heart Healthy |
| Power User | | | Badge | Participant | Meals Offered |
| Recycling | Additional Child | | Boy Scout Badge | Sponsor a Team | Gluten Free |
| | Services | | | | Available |
| Plant a Tree | Child Care | | Girl Scout Badge | | No MSG |
| | Services | | | | |
| Green Products | Child Play Area | | | | Organic |
| Offered | | | | | Ingredients |

As shown, the sub-categories may include badges representative of relationships or partnerships with other businesses or organizations (e.g., Boy Scouts). The sub-categories may be validated to prevent content providers from being fraudulent in their representation of the establishment or affiliations. For example, the search system may allow for the organizations, such as the Boy Scouts, to submit a list of business or organizations that are supportive and a cross-check may be performed by the search system. In one embodiment, the search system may auto-populate a content provider's badges by accessing information submitted by or collected from other organizations (e.g., green energy electricity provider's commercial customer list may be accessed and that sub-category may be identified as “true” for each of the commercial customers).

With regard to FIGS. 4A-4N, screen shots of illustrative profile entry screens 400a-400n, respectively, that enable a commercial entity to submit information to receive or be awarded an indicia or badge to indicate that the commercial entity meets sufficient criteria to qualify for providing a service, and therefore, enable association and display of the badges with listing content of the commercial entity is shown. FIG. 4A is a screen shot of a GUI 400a that lists “with” search parameters topics 402a-402m (collectively 402) that are available for commercial entities to select. In response to selection, the commercial entity may be prompted with qualification questions (see FIGS. 4B-4N) to answer to indicate that the commercial entity provides a certain service or subservience. As an example, as shown in FIG. 4D to receive a “Child Friendly” badge, the commercial entity is to answer questions via check-boxes or otherwise that allow the search system to deem the commercial entity a “child friendly” commercial entity (e.g., car dealership). As shown in FIG. 4D, statements and/or questions for the commercial entity to answer may include questions associated with child friendly waiting rooms, restrooms, giveaways, accommodations for children, or any other questions related to being deemed child friendly. In addition to the check-box entries, “other” text entry field 404z may enable a more substantive submission for automatic or manual review to determine qualification of a commercial entity to receive a “child friendly” badge. If automatic, an objective determination may be made as to what percentage of the statements and/or questions are indicative of services being provided by a commercial entity. If manual, then a more subjective analysis component may be used to determine whether the commercial entity qualifies for a badge.

If a commercial entity qualifies for a badge, then a “Claimed *√” or other identifier may be placed next to the badge category to indicate that the commercial entity qualified for the badge. Alternatively, color of the badge category or background of the badge category may be changed (e.g., green if claimed, red if unclaimed, yellow if partially claimed, but not yet deemed to meet the criteria). In one embodiment, the statements and/or questions provided to each type of commercial entity may be identical. Alternatively, different types of commercial entities may, have different requirements due to the varying nature of commercial entities. For example, restaurants may be provided with different criteria than amusement parks. The questionnaire provided to each type of commercial entity may be different in response to a commercial entity type being selected (not shown).

In further showing how dynamic the use of the third dimension “with” search parameter can enhance efficiency for participating commercial entities, which may include traditional businesses, organizations, governmental organizations, etc., the participating commercial entities can become dynamic with its marketing. As an example, as related to the “Community Hero” “with” search parameter (See, FIG. 4E), a commercial entity that is willing to sponsor local sports teams may indicate that willingness in its profile. A local sports team may identify such businesses by simply selecting the “Community Hero” “with” search parameter. As a result, the local sports team may contact those businesses that have agreed to sponsor local sports teams, thereby saving the local sports team time and effort in “knocking on doors” trying to find a sponsor. As another example, business that are willing to allow charity organizations (e.g., March of Dimes) to participate at their business (e.g., leaving a coin collector on the counter) may indicate that in their “Community Hero” profile. It should be understood that this concept may be expanded for use with other “with” search parameters. For example, commercial entities that are willing to switch to a “green” energy power provider may select that in their “Commitment to Green” profile, which allows for “green” energy power providers to more easily identify such commercial entities. The number of examples for expanding inter-commercial entity relationships is relatively endless as related to the “with” search parameters.

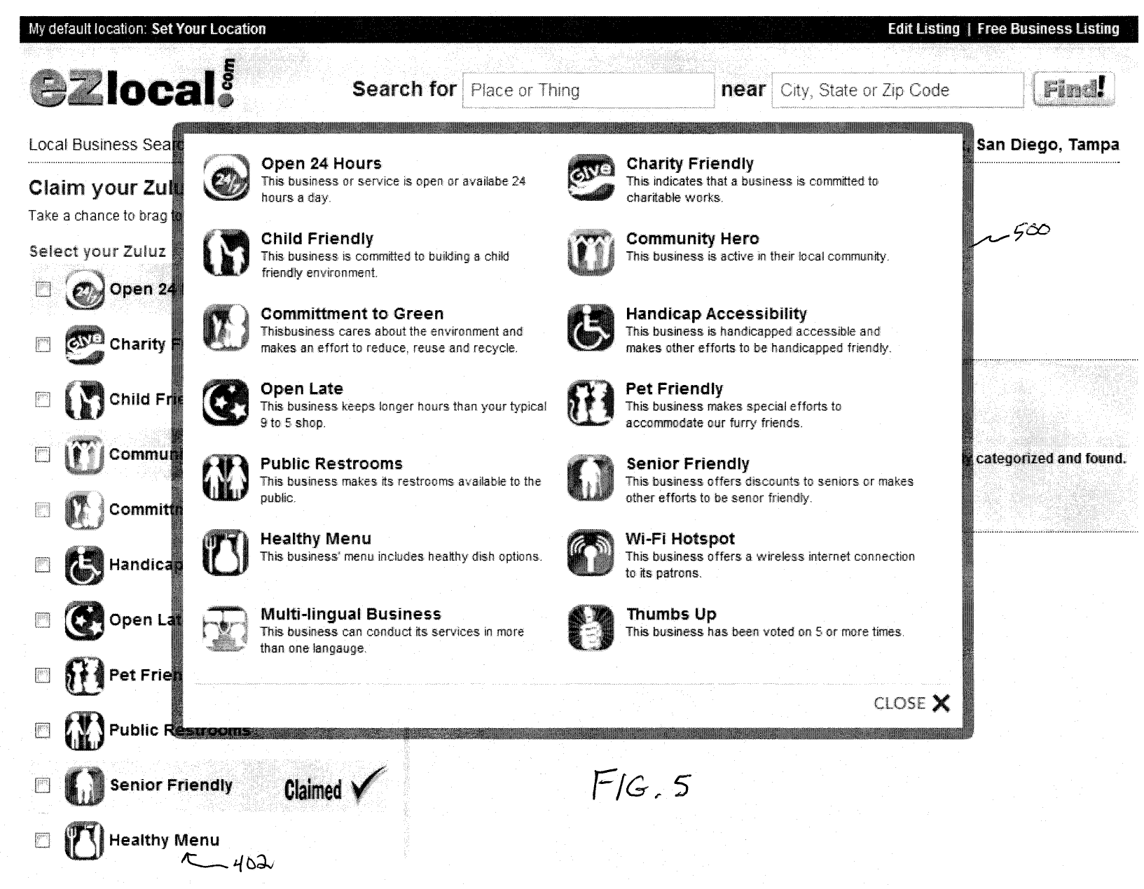

With regard to FIG. 5, a screen shot of an illustrative pop-up window 500 that provides for a brief description of the meaning of the “with” search parameter topics or badges 402 is shown. The pop-up window 500 may be accessed by a user requesting the brief descriptions of the badges 402 from the search site It should be understood that rather than using a pop-up window that any other technique (e.g., separate tab, separate screen, idea bubble, etc.) for displaying a listing of the meanings of the badges may be utilized. In one embodiment, a detailed description of the meaning of each of the badges 402 may be available for a searcher to view by selecting the indicia or badge displayed in the pop-up window 500.

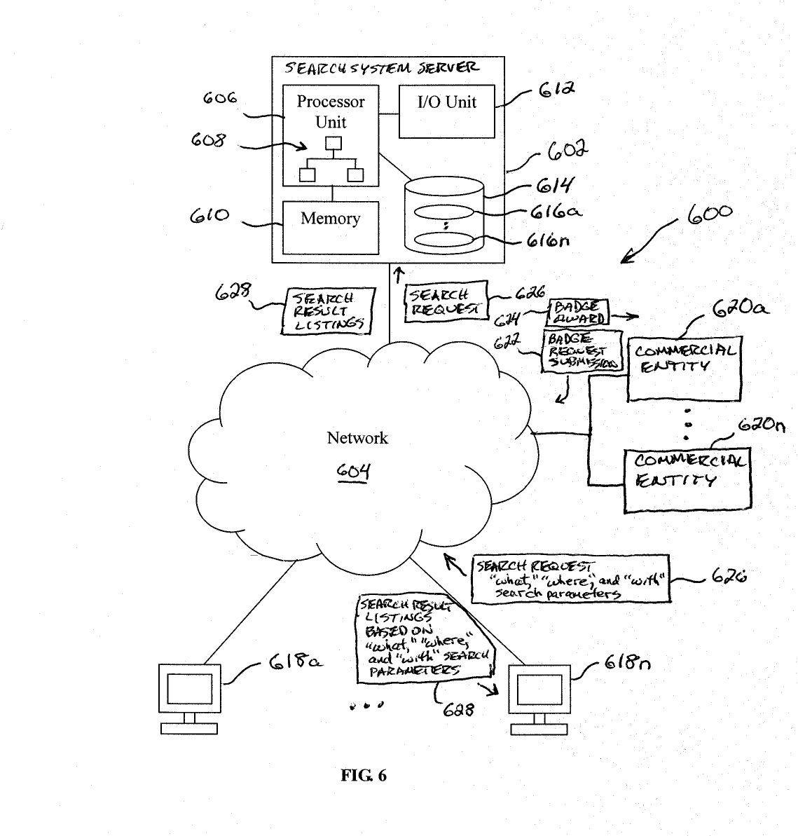

With regard to FIG. 6, an illustration of a network environment 600 that includes a search system server 602 that is operating on a communications network 604, such as the Internet, is shown. The search system server may include a processing unit 606 that executes software 608 configured to provide search functionality in accordance with the principles of the present invention. The processing unit 606 may include one or more computer processors. The processing unit 606 may be in communication with a memory 610, input/output (I/O) unit 612, and storage unit 614. The memory 610 may be configured to store data and software used by the search system in providing for searching. The data may include listings and badges associated with the listings. The data may be stored in any manner and organization that facilitates efficient and logical searching, as understood in the art The I/O unit 612 may be configured to enable the search system server 602 to communicated via the network 604. The storage unit 614 may store data repositories 616a-616n (collectively 616) that may include listings and badges associated with the listings. Additional data may be stored in the data repositories 616, as understood the in art. Although shown as a single search system server 602, it should be understood that multiple search system servers that include the same, subset(s), or different data (e.g., regional data) may be utilized in implementing the principles of the present invention. For example, to expedite searching for searchers in different geographic regions, a server may be located in different geographical regions and include data related to the specific geographical regions.

Searchers using computing devices 618a-618n (collectively 618), which may include personal computers, mobile devices, or other electronics devices that are capable of performing online searches, in communication with the search system server 602 may perform online searches for listings of commercial entities 620a-620n (collectively 620), among other information, that include “with” search parameters or badges, as previously described herein

As shown, a commercial entity 620a may register for a badge associated with a “with” search parameter with an operator of the search system server 602 by submitting a badge request submission 622 to the search system server 602 via a GUI (see FIGS. 4A-4N). The search system server 602 may, in response to receiving “with” search parameter registration information from the commercial entity 620a, as described with regard to FIGS. 4A-4N, store the information submitted in the data repositories 614. The submitted information may thereafter be utilized to determine whether a badge is to be issued to commercial entity 620a for association with other listing content provided by the commercial entity 620a. If awarded a badge, a badge award notice 624 may be communicated to the commercial entity 620a. If not awarded a badge, a rejection notice (not shown) may be communicated to the commercial entity 620a. As further previously described, the badges may be used to provide a “third dimension” search parameter to assist searchers with identifying listing information that is relevant for a search. The commercial entities 620 that are awarded badges may have improved search listing performance over non-badge commercial entities as the badges may improve relevance ranking scores.

In performing a search, a searcher using computing device 618n may submit a search request 626 to the search system server 602 via the network 604. The search request may include any or all of “what,” “where,” and “with” search parameters. The search system server 602, in response to receiving the request, perform the search using the search parameter(s) and generate a search result listing 628 based on the “what,” “where,” and “with” search parameter(s) submitted in the search request 626. The search result listing 628 may be communicated to the computing system 618n for display and review by the search.

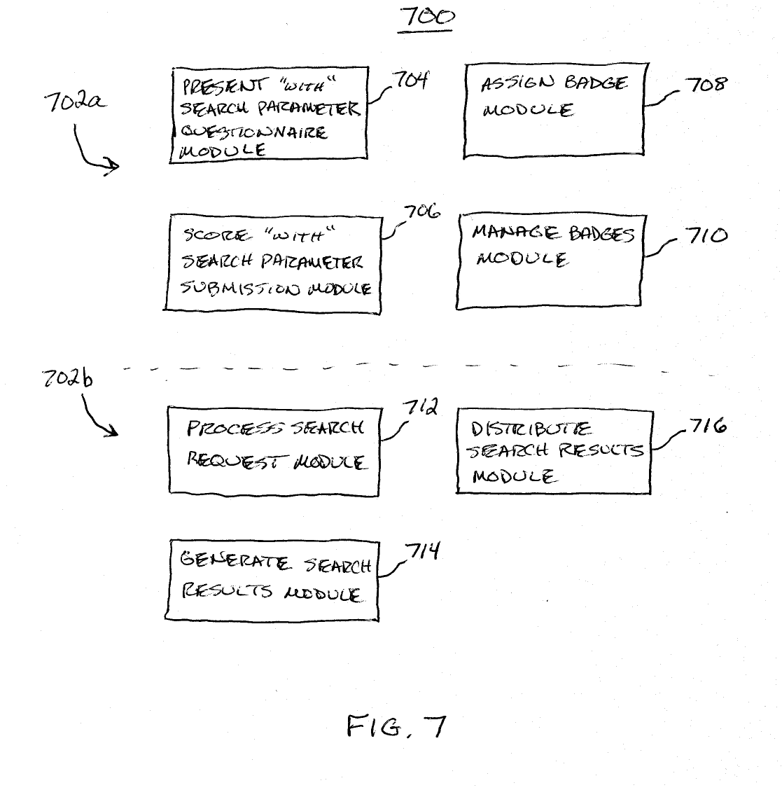

With regard to FIG. 7, a block diagram of illustrative software modules 700 is shown to include a first set of software modules 702a configured to manage request submissions by commercial entities to obtain badges to be associated with listing content and software modules 702b configured to managing online searches that include a “with” search parameter along with “what” and “where” search parameters. The software search modules 702a may include a present “with” search parameter questionnaire.

A “with” search parameter questionnaire module 704 may be configured to include statements and/or questions (see FIGS. 4A-4N) that a commercial entity may use to identify what services and/or goods the commercial entity provides. The module 704 may access a data repository in which the content of the questions are managed by a service provider that manages a search system that includes “with” search parameters. The module 704 may further be configured to present a questionnaire to a user that includes GUI elements from which a user may indicate whether a commercial entity provides goods or services.

A score “with” search parameter submission module 706 may be utilized to score or otherwise determine whether a commercial entity that submits to receive a badge for a particular “with” search parameter topic. The module 706 may provide for an objective determination based on what questions or statements are made in the affirmative (e.g., 80% or higher affirmative answers may be considered a passing score). The objective determination may vary for awarding a badge based on topic. For example, if one topic has three questions, then the passing rate may be 67% (i.e., two-thirds), but if another topic has 10 questions, then the passing rate may be set to 70% (i.e., 7 out of 10). In one embodiment, a subjective analysis may be performed if a commercial entity is able to submit a written description, as opposed to simple check-boxes, to describe a certain aspect of their business related to a “with” search parameter. Still yet, different weighting may be applied to statements and/or questions provided to a commercial entity in a questionnaire in determining whether the commercial entity is to be awarded a badge to be associated with content of the commercial entity.

An assign badge module 708 may be configured to access a score generated by the module 706 associated with “with” search parameter topic and, if the score is a passing score, assign or otherwise associate a badge with content of a commercial entity. In assigning the badges, the badges or identifiers used to indicate that the badges are associated with the content, may be associated either directly (i.e., listed in a data repository that includes the content) or indirectly (i.e., referenced from the data repository that includes the content). Once assigned, future searches that are performed that include a “with” search parameter that match the badge results in the content having a higher search ranking.

A manage badges module 710 may manage the badges that have been assigned to the entities. In managing the badges, the module 710 may maintain the badges in association with the content. The module 710 may also provide for a periodic update check (e.g., annually) to confirm that the commercial entity is still providing services associated with the badge. If the content of the commercial entity is updated, such as the address of the commercial entity changing, then the module 710 may actively request update from the commercial entity.

A process search request module 712 may be configured to receive and process a search request from a user. The search request may include one or more “what,” “where,” and “with” search parameters. If the one or more search parameters are provided by different data fields, including “check-boxes” for the “with” search parameter, then the module 712 may simply apply the different search parameters to the search algorithm. If the one or more search parameters are from a single search data field, then the module 712 may parse the inputs to identify the “what,” “where,” and “with” search parameter(s).

A generate search results module 714 may be configured to perform a search from content (e.g., listings) using the search parameter(s) and generate search results. The search results may be generated in a traditional search results form with the addition of listing badges, thereby allowing for the search to identify how well the “with” search parameter matched to the search results. In one embodiment, the search results may limited badges to simply those that were submitted in the “with” search parameter or list all badges that are associated with each listing.

A distribute search results module 716 may distribute the search results determined by the module 714. The distribution of the search results may be distributed to a browser or other graphical user interface with which the searcher is utilizing in performing the search.

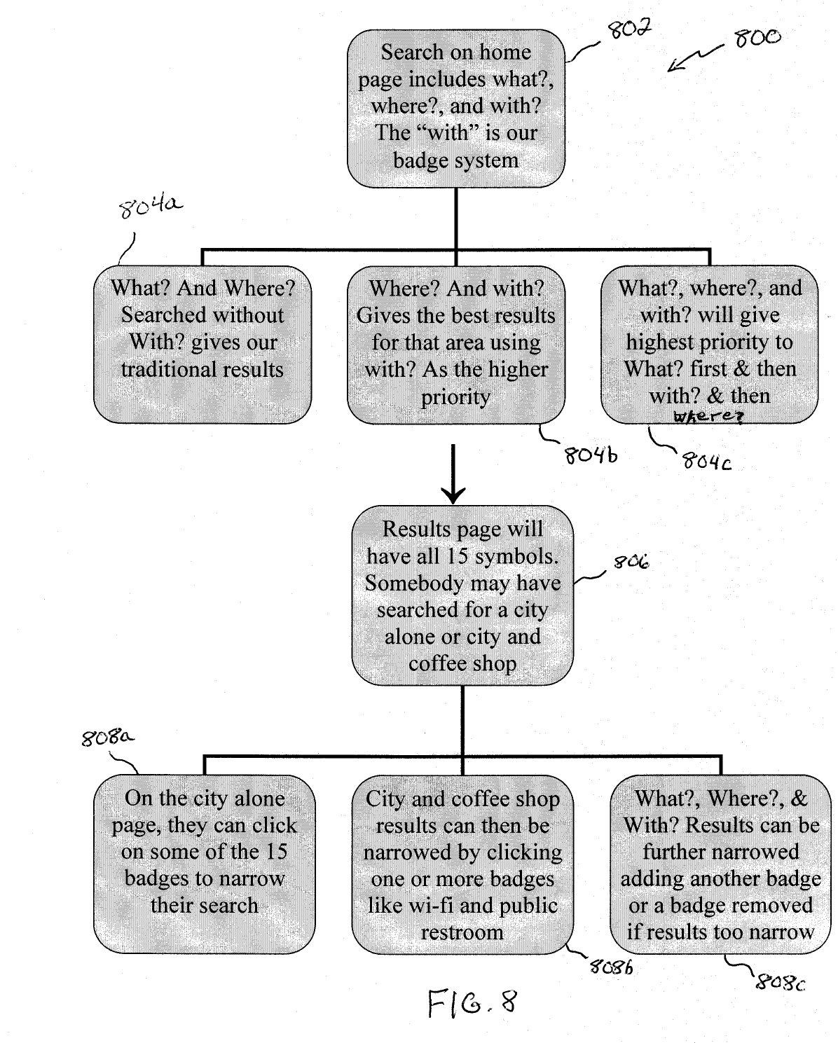

With regard to FIG. 8, a flow diagram of an illustrative process 800 for a search algorithm that includes a “with” search parameter to be executed on a computing system, such as shown in FIG. 6. The process may include prioritizing the “with” search parameter depending on whether either or both of “what” and “where” search parameters are submitted by a searcher. The process 800 may start at step 802, where a search on a home page may include “what,” where,” and/or “with” search parameters. Depending on which of the search parameters are entered, the process 800 may continue at one of steps 804a, 804b, and 804c. If “what” and “where” search parameters are submitted, then the search process is performed by step 804a, where a search is performed that produces traditional search results. The traditional search results may or may not display badges. If “where” and “with” search parameters are submitted, then the process continues at step 804b, where a search is performed in a geographic area with the “with” search parameter being the higher priority. If “what,” “where,” and “with” search parameters are submitted, then a search is performed with priority given to “what,” “with,” and “where” search parameters in that order. It should be understood that the ordering and priority of the search parameters may result in different search results. It may further be understood that the search parameter priority may be altered based on a profile established by a searcher, as previously described, that that the priority may ultimately be controlled by logical searching operations.

At step 806, a results page may display all or a portion of the badges (i.e., “with” search parameters) that a search may utilize for a search. The searcher, after reviewing the search results, may elect to select one or more of the “with” search parameters to further refine the search. As shown, at step 808a, the searcher may elect to include one or more “with” search parameters (i.e., add badge(s) to narrow the search). At step 808b, the searcher may further narrow the results by selecting one or more “with” search parameters. It should be understood that the narrowing of the search results may cause another search to be performed or display a subset of the search results to the searcher without initiation of another search. At step 808c, if each of the three search parameters were initially submitted, then additional or fewer “with” search parameters may be selected to further narrow or broaden the search results. If “with” search parameters are removed, then another search may be initiated.

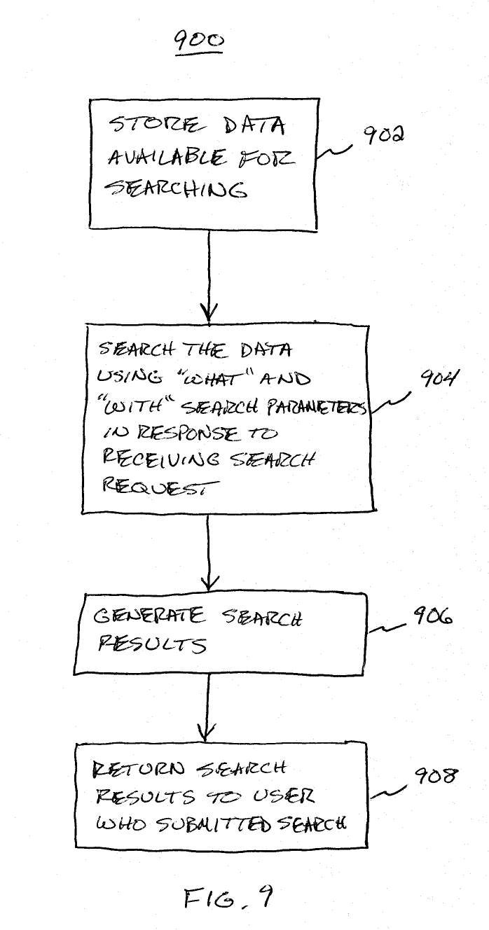

With regard to FIG. 9, an illustrative process 900 for performing searches is shown. The process 900 starts at step 902, where data available for searching is stored. The data may be stored for index searching, as understood in the art. As the data includes “with” search parameter(s), data records or data structures that are used to store the data may be configured to provide for searching of “what,” “where,” and “with” search parameters. At step 904, the data may be searched using “what” and “with” search parameters in response to receiving a search request that includes “what” and “with” search parameters. In one embodiment, a “where” search parameter may be searched as well. Alternatively, a different combination of the three search parameters may be used to perform a search. At step 906, search results may be generated. The search results may be ranked according to priority for the search, as previously described. The search results may include all badges associated with search listings or be limited to badges that were selected to be part of the search. At step 908, search results may be returned to a user who submitted the search. The search results may be ordered based on rankings as established by the search engine or in accordance with preferences of the user.

While the use of badges and “with” search parameters have been described with regard to commercial entities, it should be understood that non-commercial entities, including individuals, may utilize the principles of the present invention. It should also be understood that search parameters in addition to the three search parameters presented herein may also be utilized.

The previous description is of a preferred embodiment for implementing the invention, and the scope of the invention should not necessarily be limited by this description. The scope of the present invention is instead defined by the following claims.

What is claimed:

1. A system for performing searches, comprising:
an input/output (I/O) unit configured to receive and transmit over a communications network;
a memory configured to store data; and
a processing unit in communication with said I/O unit and said memory, said processing unit configured to receive search request data via said I/O unit, the search request data including a “what” search parameter and a “with” search parameter, said processing unit further configured to, in response to receiving the “what” and “with” search parameters, perform a search of data stored in said memory using the “what” and “with” search parameters and return results of the search via said I/O unit to a requestor of the search request.

2. The system according to claim 1, wherein the “with” search parameter is received in a separate data field from the “what” search parameter.

3. The system according to claim 1, wherein the “what” search parameter is searched using a higher search priority then the “with” search parameter.

4. The system according to claim 1, wherein the “with” search parameter is a data value selected from among a plurality of pre-established search data values.

5. The system according to claim 1, wherein said processing unit further configured to, in response to receiving a “where” search parameter, perform a search parameter after performing the search using the “what” and “with” search parameters.

6. The system according to claim 5, wherein said processing unit is configured to receive the “what,” “where,” and “with” search parameters substantially simultaneously for use in performing the search using the three search parameters.

7. A method for performing searches, said method comprising:
storing data available for searching;
in response to receiving a search request includes a “what” search parameter and a “with” search parameter from a user, searching the data using the “what” and “with” search parameters;
generating search results; and
returning the search results to a user who submitted the search request.

8. The method according to claim 7, wherein receiving the “what” and “with” search parameters in separate data fields.

9. The method according to claim 7, wherein searching includes searching giving the ‘what” search parameter a higher priority than the “with” search parameter.

10. The method according to claim 7, wherein receiving the “with” search parameter is a data value selected from among a plurality of pre-established search data values.

11. The method according to claim 7, further comprising:
receiving a “where” search parameter; and
performing the search of the data using the “where” search parameter after performing the search using the “what” and “with” search parameters.

12. The method according to claim 11, wherein receiving includes receiving the “what,” “with,” and “where” search parameters substantially simultaneously for performing the search using the three search parameters.

13. A method for providing an online search system, said method comprising:
enabling a commercial entity to submit qualification information indicative of services provided in association with a “with” search parameter;
determining whether the qualification information submitted by the commercial entity qualifies the commercial entity to have a badge assigned to the commercial entity;
assigning a badge to the commercial entity, the assignment including associating a badge with content associated with the commercial entity; and
searching, in response to receiving a search request that includes a “with” search parameter, for the badge in addition to the content associated with the commercial entity; and
generating search results that include the content associated with the commercial entity and the badge in response to determining that the content and badge at least in part match the search request.

14. The method according to claim 13, wherein enabling the commercial entity to submit qualification information includes providing a questionnaire to allow the commercial entity to select information to submit that are indicative as to what services are provided by the commercial entity that relate to the “with” search parameter.

15. The method according to claim 13, wherein searching includes prioritizing the search for the badge based on whether “what” and “where” search parameters are also submitted for the search.

16. The method according to claim 13, further comprising associating badges with the commercial entity based on business relationships that the commercial entity has with other commercial entities.

17. The method according to claim 13, further comprising requesting updates from the commercial entity about the “with” search parameter to determine whether the assigned badge is to be maintained.

18. The method according to claim 13, wherein searching includes prioritizing “where” and “what” search parameters as a function of search parameters that were submitted in the search.

19. The method according to claim 13, further comprising enabling the searcher to refine the search results by selecting or deselecting “with” search parameters after being presented with the search results.

20. The method according to claim 13, further comprising:
presenting the searcher with a listing of “with” search parameters in the form of selectable indicia; and
in response to receiving selection of one or more indicia, performing the search using the selected indicia as “with” search parameters.
